(19) United States
(12) Patent Application Publication
(10) Pub. No.: US 2010/0111155 A1
(43) Pub. Date: May 6, 2010

(54) Serial Decode Correlation And Navigation

(76) Inventors: Christopher P. Duff, Colorado Springs, CO (US); Cheryl Fincher, Colorado Springs, CO (US); Bruce A. Erickson, Colorado Springs, CO (US); Jay A. Alexander, Monument, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/263,852

(22) Filed: Nov. 3, 2008

(51) Int. Cl. H04B 17/00

(52) U.S. Cl. 375/228; 455/67.7

(57) ABSTRACT

An instrument screen display includes a unique marker that provides the correlation and navigation through the analog data. The marker tells the user which packet or symbol is being displayed in the analog trace. The selected line in the listing (listing row that is blue) and the blue line on the trace above indicate which packet is selected for the purpose of showing details and packet data in the other tabs in the listing window. In addition to correlation, navigation can occur from either display. This type of marker is an innovative approach to correlating and navigating the disparate data types displayed on a modern oscilloscope.

### BACKGROUND

Modern oscilloscopes do much more than measure voltage and time. Agilent Oscilloscopes were the first to include 8b/10b decoding and a protocol view of a serial bus, described in U.S. Ser. No. 10/799,139, “Display of Digital Interface Symbol Information from an Analog Signal”, assigned to Agilent Technologies. This technology brings the protocol decoding capability of a protocol analyzer or logic analyzer into an oscilloscope. By displaying protocol in a scope, users can see signal integrity causes of logic faults. When incorrect packets of data are received, is it because they were transmitted incorrectly or because the electrical system that carried the data changed it?

Different display formats are used to convey the different layers of information contained in the signal. The traditional analog display of the signal is typically the focal point on an oscilloscope. However, once the signal is decoded into 8b/10b symbols or packets of data, it is preferred that this information be displayed in a listing similar to a logic analyzer or protocol analyzer. Hence the Agilent oscilloscopes represent this data as follows with the analog signal displayed at top in voltage and time and a listing below showing the logical content of the entire signal acquisition.

The user must examine the analog signal and look at specific bits to understand the nature of signal integrity issues. Was there a power supply switching, activity on an adjacent line causing crosstalk, etc? However, to see which packet is at fault requires the user to examine a broad span of time. There needs to be a way to correlate the information in the listing below to the analog signal above.

### SUMMARY

The present invention includes a unique marker that provides the correlation and navigation through the analog data. The blue line on the analog trace in the screen shot above is correlated to the blue selected line in the listing. This tells the user which packet or symbol is being displayed in the analog trace. The selected line in the listing (listing row that is blue) and the blue line on the trace above indicate which packet is selected for the purpose of showing details and packet data in the other tabs in the listing window.

In addition to correlation, navigation can occur from either display.

This type of marker is an innovative approach to correlating and navigating the disparate data types displayed on a modern oscilloscope.

### BRIEF DESCRIPTION OF THE DRAWINGS

FIG. 1 shows a screen of the interface according to the invention.

FIG. 2 shows a process flowchart according to the invention.

FIG. 3 shows a process flowchart for step 100A shown in FIG. 2.

FIG. 4 shows a functional block diagram according to the invention.

### DETAILED DESCRIPTION

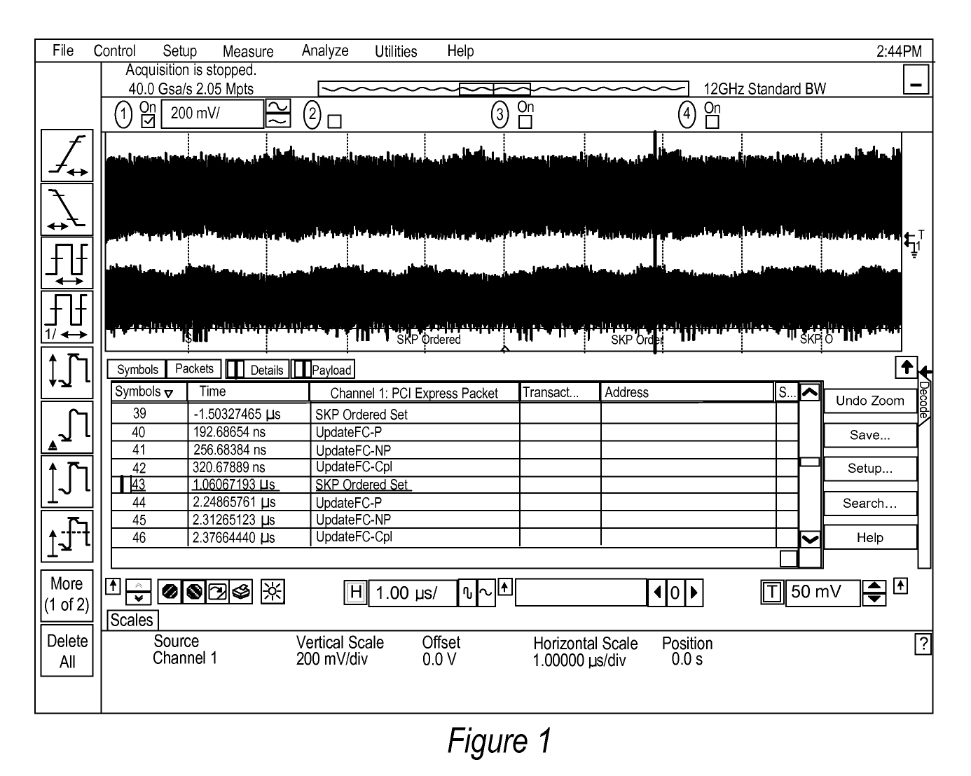

FIG. 1 shows a screen of the interface according to the invention.

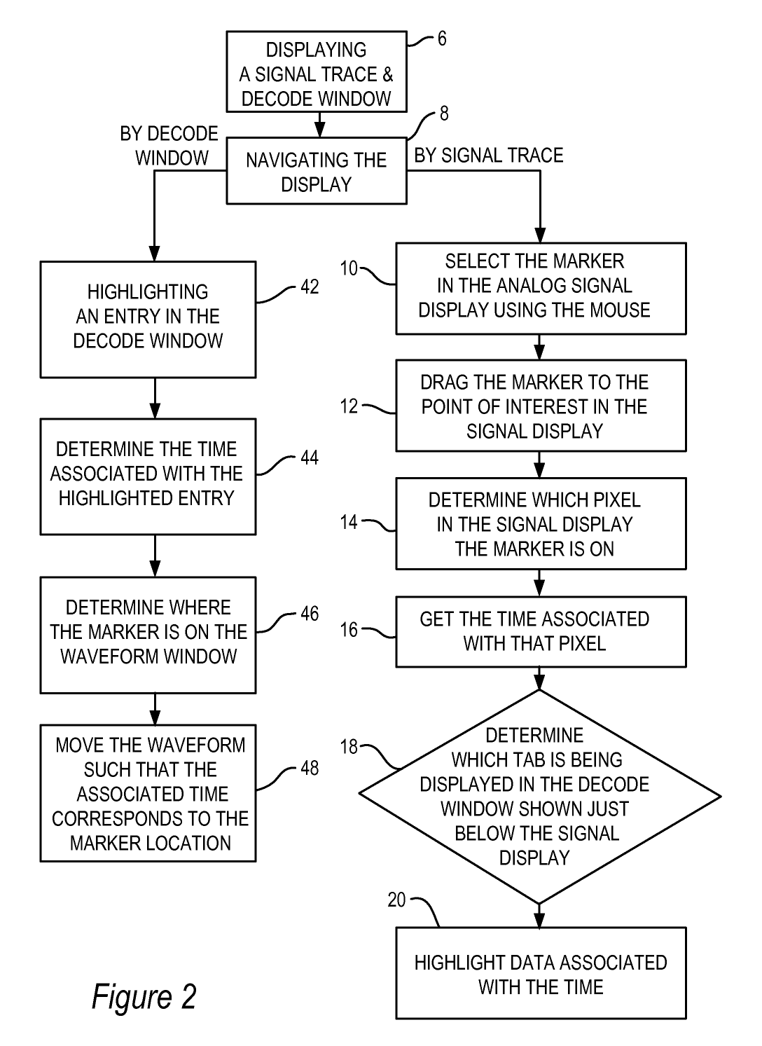

FIG. 2 shows a process flowchart according to the invention. In step 6, a signal trace and decode window are displayed. In step 8, the display is navigated by either decode window or signal trace.

When the display is navigated by decode window, in step 42, the entry in the decode window is highlighted. In step 44, the time associated with the highlighted entry is determined. In step 46, the position of the marker in the waveform window is determined. In step 48, the waveform is moved such that the associated time corresponds to the marker location.

When the display is navigated by signal trace, in step 10, a visual marker is selected. The marker may be selected in the analog signal display. In step 12, the marker is positioned to the point of interest in the signal display. In step 14, it is determined which pixel in the signal the marker is on. In step 16, the time associated with the pixel is determined. In step 18, it is determined which tab is selected in the decode window. In step 20, the data associated with the time is visually emphasized. In the illustrative example shown in FIG. 1, the decode window is shown just below the signal display.

In operation, if the focus of attention is the analog trace, the user can move the blue line and see the corresponding selected line in the listing move. If necessary, the listing will automatically scroll to display the selected listing row. If the user pulls the blue line off the grid to the left or right, the analog trace will automatically start shifting one packet or symbol at a time. This will also have the effect of scrolling the listing if necessary. If the focus of attention is the listing, the user can scroll the listing and select the desired row by clicking on it. When the user clicks on a row in the listing, the analog trace will shift to place the middle of the selected symbol or packet at the location of the blue line.

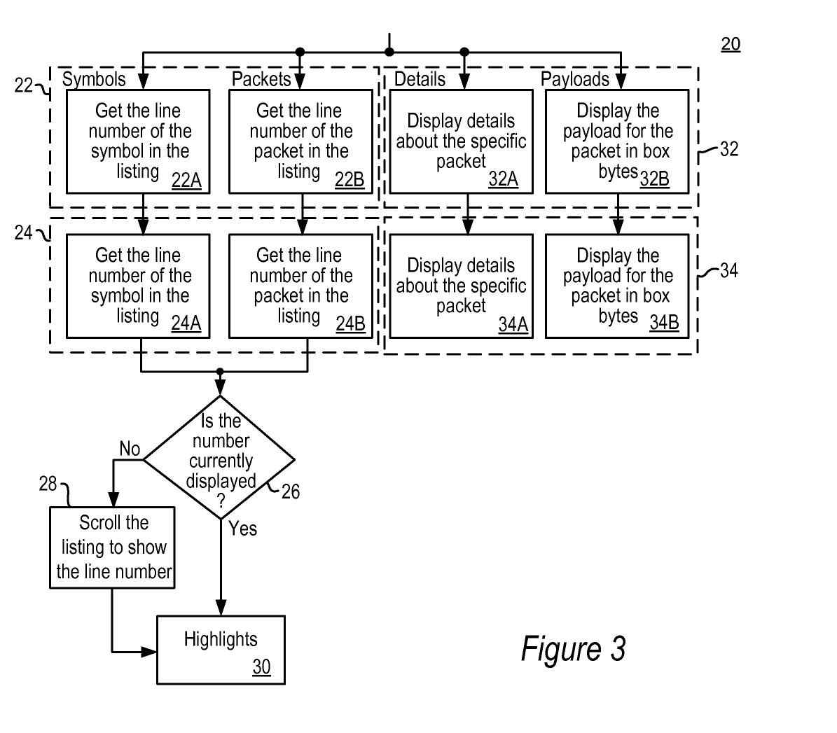

FIG. 3 shows a process flowchart for step 20 shown in FIG. 2. There are two illustrative tabs shown. The first tab is indirectly associated data while the second tab is for directly associated data.

For indirectly associated data, in step 22, the representation associated with the time is obtained. If the index is a symbol then the symbol associated with the time is found (shown in step 22A). If the index is a packet, the packet associated with the time is found (shown in step 22B). In step 24, the line number associated with the data entry is obtained (shown in steps 24A and 24B). In step 26, it is determined whether the line number currently displayed corresponds to the time of interest. If no, then in step 28, the listing is scrolled to show the corresponding line number. If yes, then in step 30, a visual indicator is initiated. The visual indicator may be a change in the background color of the line, highlighting the entry, “blinking” the entry, etc.

For directly associated data, in step 32, the packet associated with the time is obtained. In step 34, data specific to the selected parameter is displayed. If the selected parameter is “details” then details about that specific packet are displayed (shown in step 32A and 34A). If the selected parameter is “payload”, the payload for the packet may be displayed in hexadecimal bytes (shown in steps 32B and 34B).

As an alternative, the user may customize the screen views that are displayed or add additional views.

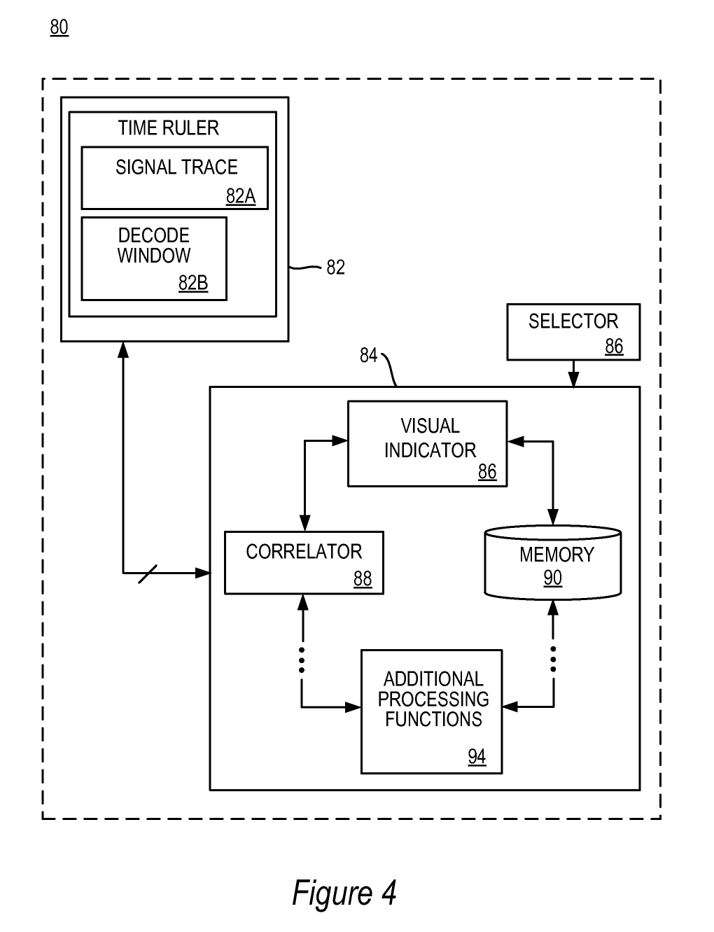

FIG. 4 shows a functional block diagram according to the invention. An instrument 80, e.g. an oscilloscope, includes a signal display 82 and a processor 84. A selector 86 positioning a marker on the signal display. The selector 86 may be mouse, touchpen, knob, keyboard, or touchscreen.

The processor 84 includes a correlator 88, memory 90, visual indicator 92, and additional processing functions 94. The correlator 88 determines a location for a pixel in the signal display corresponding to a position of the marker. The correlator 88 then converts pixels to time. Memory 90 contains times associated with the pixel and the location. A visual indicator 92 highlights a tab in a decode window corresponding to the time and marker.

The signal display 82 includes a signal trace 82A and the decode window 82B. The signal display 82A may also include a measurement of time.

We claim:

1. A method comprising:
for an analysis instrument,
displaying a signal trace on a screen; and
navigating the signal trace by one of positioning the marker on the screen and selecting an entry in the decode window.

2. A method, as in claim 1, wherein navigating the signal trace is positioning the marker on the screen, further comprising:
correlating a location for a pixel in the signal display corresponding to the marker position;
determining a time associated with the pixel; and
highlighting an entry in a decode window corresponding to the time and marker.

3. A method as in claim 2, wherein a tab is selected from a group including a symbol and a packet, further comprising:
associating a data entry with the determined time;
obtaining a line number corresponding to the data entry;
determining whether the line number currently displayed corresponds to the determined time; and
visually indicating the corresponding line number in the decode window.

4. A method as in claim 3, wherein the entry displays data associated with the one of a symbol and a packet.

5. A method as in claim 3, when the selected tab is a symbol, associating the symbol with the time obtained.

6. A method as in claim 3, when the selected tab is a packet, associating the packet with the time obtained.

7. A method as in claim 3, wherein the visual indicator is selected from a group including changing in the background color of the line, highlighting the entry, and “blinking” the entry.

8. A method as in claim 2, wherein the signal display includes a visual measurement of time.

9. A method as in claim 2, further comprising:
shifting the marker position; and
dynamically identifying the shifted marker position.

10. A method as in claim 1, wherein navigating the signal trace is highlighting an entry in the decode window.

11. A method as in claim 10, further comprising:
determining the time associated with the new entry;
determining where the marker is in the waveform window; and
moving the waveform such the associated time corresponds to the marker location.

12. A system comprising:
an analysis instrument having a signal display and a processor;
a selector for positioning a marker on the signal display, in communication with the processor; and
wherein the processor includes
a correlator, determining a location for a pixel in the signal display corresponding to a position of the marker and converting pixel data into time,
memory containing times associated with the pixel and the location, and
a visual indicator highlighting a tab in a decode window corresponding to the time and marker;
wherein the signal display includes a signal trace and the decode window.

13. A system as in claim 12, wherein the memory includes a symbol associated with the time.

14. A system as in claim 12, wherein the memory includes a packet associated with the time.

15. A system as in claim 12, wherein the visual indicator is selected from a group including changing in the background color of the line, highlighting the entry, and “blinking” the entry.

16. A system as in claim 13, wherein the signal display includes a visual measurement of time.

17. A method comprising:
for an analysis instrument,
displaying a signal trace on a screen;
highlighting a tab in a decode window corresponding to the timer and marker
correlating a location for a pixel in the signal display corresponding to the marker position;
determining a time associated with the pixel; and
displaying a marker on the screen.
